(19) United States
(12) Patent Application Publication
(10) Pub. No.: US 2011/0160998 A1
(43) Pub. Date: Jun. 30, 2011

(54) METHOD AND APPARATUS FOR CONDITIONAL EVENT PLANNING

(75) Inventor: Kari Antero Rissanen, Espoo (FI)

(73) Assignee: Nokia Corporation, Espoo (FI)

(21) Appl. No.: 12/648,819

(22) Filed: Dec. 29, 2009

(51) Int. Cl. G06F 3/048; G01C 21/00

(52) U.S. Cl. 701/201; 715/772

(57) ABSTRACT

An approach is provided for generating a conditional event. Temporal parameters relating to multiple features are received from services that provide such information and user profile information specifying criteria for those parameters is retrieved. An event is caused to be generated if the temporal parameters satisfy those criteria.

### BACKGROUND

Service providers (e.g., wireless, cellular, etc.) and device manufacturers are continually challenged to deliver value and convenience to consumers by, for example, providing compelling network services and advancing the underlying technologies. One area of interest has been the development of services and technologies for electronic event organizers. Traditional event organizers enable event generation based on limited features such as a user's availability. But, the system architecture of current event organizers does not support extension of the system to include other features. Consequently, users are unable to automatically generate events, but rather must manually determine whether the values of features beyond those offered meet user-desired criteria. Such an approach is time-consuming and error-prone.

### SOME EXAMPLE EMBODIMENTS

Therefore, there is a need for an approach for generating conditional events based on temporal parameters satisfying criteria relating to an electronic calendar event.

According to one embodiment, a method comprises receiving one or more temporal parameters relating to a plurality of features. The method also comprises retrieving user profile information specifying a predetermined criterion associated with an electronic calendar event. The method further comprises evaluating the received temporal parameters according to the predetermined criterion and generating an event if the predetermined criteria are satisfied.

According to another embodiment, an apparatus comprising at least one processor, and at least one memory including computer program code, the at least one memory and the computer program code configured to, with the at least one processor, cause, at least in part, the apparatus to receive one or more temporal parameters relating to a plurality of features. The apparatus is also caused to retrieve user profile information specifying a predetermined criterion associated with an electronic calendar event. The apparatus is further caused to evaluate the received temporal parameters according to the predetermined criterion and generate an event if the predetermined criteria are satisfied.

According to another embodiment, a computer-readable storage medium carrying one or more sequences of one or more instructions which, when executed by one or more processors, cause, at least in part, an apparatus to receive one or more temporal parameters relating to a plurality of features. The apparatus is also caused to retrieve user profile information specifying a predetermined criterion associated with an electronic calendar event. The apparatus is further caused to evaluate the received temporal parameters according to the predetermined criterion and generate an event if the predetermined criteria are satisfied.

According to yet another embodiment, an apparatus comprises means for receiving one or more temporal parameters relating to a plurality of features. The apparatus also comprises means for retrieving user profile information specifying a predetermined criterion associated with an electronic calendar event. The apparatus further comprises means for evaluating the received temporal parameters according to the predetermined criterion and generating an event if the predetermined criteria are met.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of generating conditional events based on the temporal values of features, according to one embodiment;

FIG. 2 is a diagram of the components of the event platform of FIG. 1, according to one embodiment;

FIGS. 3A-3D are flowcharts of processes associated with generating and reevaluating events based on temporal parameters, according to various embodiments;

FIG. 4 is a diagram of a user device capable of generating conditional events based on the temporal values of features, according to one embodiment;

FIG. 5 is a diagram of an exemplary user interface for the system of FIG. 1, according to one embodiment;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for generating conditional events based on the temporal values of features are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

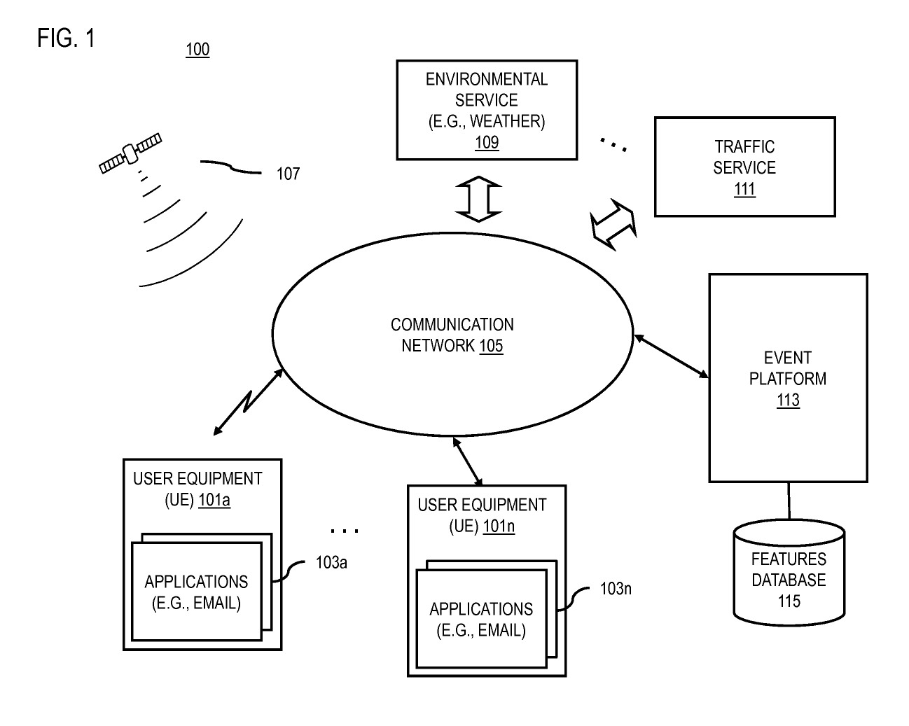

FIG. 1 is a diagram of a system capable of generating conditional events based on the temporal values of features, according to one embodiment. To set up a meeting using the current generation of electronic event organizers, users must perform a large amount of manual work to evaluate conditions beyond simple attendee availability—e.g., checking weather and traffic conditions, verifying equipment availability, determining whether a certain threshold number of invitees are available to attend, etc. Evaluating these conditions can be especially burdensome because they vary as meeting parameters change. For example, for a 9 A.M. meeting, the weather may be cold and rainy and the traffic may be heavy, while, for a 3 P.M. meeting, the weather is sunny and warm and traffic is light. Organizers are further tasked with maintaining a record of their preferences with respect to acceptable values for the various conditions. The above activities traditionally are largely manual, involving manipulating one or more applications and repeatedly “opening and closing” these applications to modify or update the data. The continual invocation and use of the application are a drain on device resources (e.g., power and processing), thereby reducing the battery life of the mobile device.

To address this problem, a system 100 of FIG. 1 introduces, in certain embodiments, the capability to conveniently generate a conditional event. According to one embodiment, the system 100 enables generation of a meeting request when, for example, environmental conditions change—e.g., the outside temperature falls within a range specified in a user's profile settings. In other embodiments, the system 100 triggers other actions, such as delivery of a message or launching of an event, if the user profile criteria are met. Event generation can be based on an array of features, including traffic conditions, location information, availability of potential participants, population in a given area, availability of equipment, etc. An advantage of enabling event generation based on conditions of temporal values as set forth in a user's profile is that users can re-evaluate whether the conditions are met—i.e., at a later time or at intervals—without having to manually re-enter the conditions. Thus, a means for conveniently generating an event based on the values of features meeting certain user-specified criteria is used in some embodiments. This mechanism permits efficient use of device resources, resulting in power savings, and thus, effectively extending battery life.

Under the scenario of FIG. 1, a system 100 includes user equipments 101a-101n having connectivity to an event platform 113 and services 109 and 111 via a communication network 105. The system 100 can further include a global positioning satellite 107 for route planning and other location-related applications. As used herein, one embodiment provides UEs 101a-101n, each having one or more applications resident thereon. Applications 103a-103n can include time management and/or messaging applications such as a calendar application, an email application, a virtual meeting application, a polymorphic notes application, a group calling application, etc. Thus, users can generate events using these applications in the typical way—e.g., by UEs 101a-101n exchanging communication messages with each other to determine invitee availability at a given meeting time and location followed by manual generation of an event. Alternatively, the communication history between UEs 101a-101n as recorded on a shared polymorphic note can be used to facilitate generation of a meeting, which is more fully described in U.S. patent application Ser. No. 12/605,934, entitled, “Method and Apparatus for Generating a Polymorphic Note” (filed Oct. 26, 2009), which is incorporated herein by reference in its entirety.

To allow more convenient and more powerful conditional event planning, the event platform 113 of one embodiment enables generation of an event based on temporal parameters satisfying criteria associated with a calendar event. In one embodiment, the event platform 113 receives the temporal parameter values by accessing one or more services configured to maintain such values via a communication network 105. Services can include, among others, a traffic service 111 for providing road conditions and an environmental service 109 for providing weather-related data, internet data, sensor data, and any other data that can be communicated to the event platform 113.

The event platform 113 can, in another embodiment, store information relating to available features and/or user profile information—i.e., conditions—on a features database 115. Available features can include, for example, temperature, traffic, number of available attendees, etc. User profile information, on the other hand, can include a Boolean or other logical expression setting forth one or more criteria that the temporal parameters must satisfy. In one embodiment, the criteria specify threshold values for the features. For example, if the available features are temperature and humidity, the user profile information might include criteria requiring a temperature of less than 90 degrees and a humidity of less than 70%. In such a case, failure to satisfy either criterion causes event generation to fail, though, in another embodiment, the user profile information stored in features database 115 may require satisfaction of only one of the criteria (e.g., an OR expression).

In another embodiment, the user profile information additionally includes one or more time-related criteria. Time-related criteria may include a specific, latest and earliest time at which the temporal parameters should be evaluated, a time by which a participant must confirm, a time by which an event call must be sent, etc. That is, the time-related criteria may indicate that the temporal parameters be evaluated according to the user-specified criteria at 3 P.M. on Tuesday. The time-related criteria may further specify a time window—i.e., by specifying a start time and an end time that define the time window—during which an event can occur. The selected window can define the time period most suitable for the event based on other conditions such as weather, traffic, and/or when the greatest number of users are available, etc. In some embodiments, updated temporal parameters—i.e., temporal parameters at a later time—can be re-evaluated according to the user-specified criteria and an event can be generated based on satisfaction of the criteria. User profile information can also include criteria for participant replies.

Satisfaction of the specified criteria may generate an event as discussed but may alternatively, in other embodiments, trigger various actions such as launching of events, delivery of messages, route planning, etc. Where the action is the generation of an event, distribution of event invitation(s) can be performed via short message service (SMS), multimedia messaging service (MMS), email, or similar means. Updating of the event calendar can be via mobile device or on a network element (e.g., server), which can then be synchronized to the user's mobile device.

As shown in FIG. 1, the system 100 comprises a user equipment (UE) 101 having connectivity to an event platform 113, an environmental service 109, and a traffic service 111 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.).

By way of example, the UE 101, the event platform 113, the environmental service 109, and the traffic service 111 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

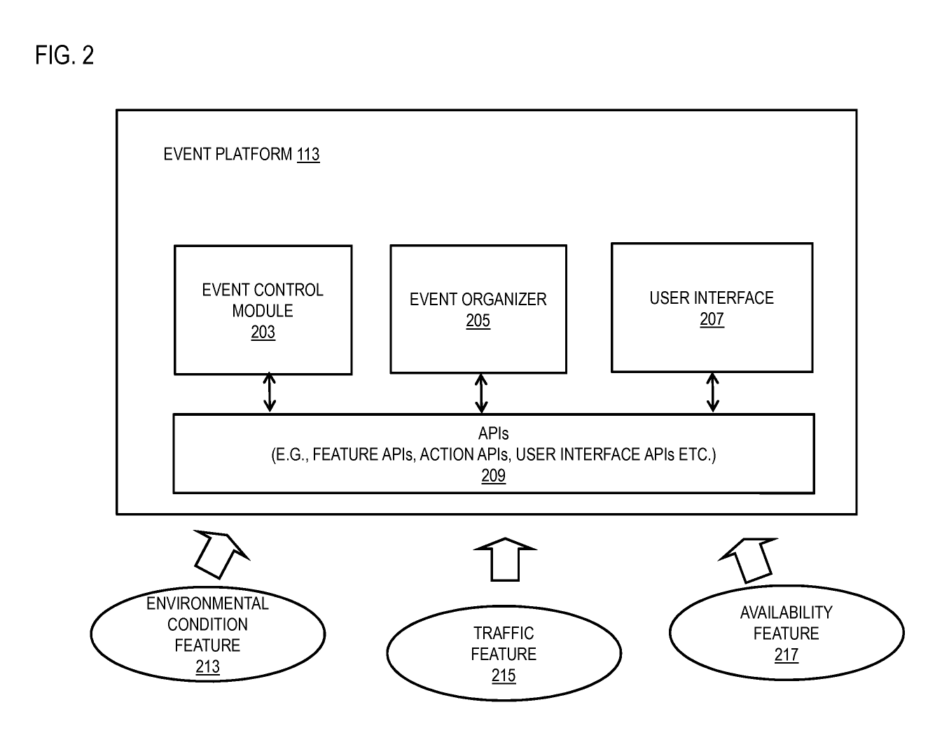

FIG. 2 is a diagram of the components of the event platform 113, according to one embodiment. By way of example, the event platform 113 includes one or more components for providing generation of conditional events based on the temporal values of features. It is contemplated that the functions of these components may be combined in one or more components or performed by other components of equivalent functionality. In this embodiment, the event platform 113 includes an event control module 203 for conditional event generation, an event organizer 205, a user interface 207 and application programming interfaces (APIs) 209.

According to certain embodiments, an API is an application interface that enables a developer to conveniently link a piece of software to the system. For example, if a new sensor type is utilized, then the sensor may be linked to the system (e.g., event platform 113) by developing code (or generating hardware, or a combination software and hardware) that interfaces with the sensor and interprets the sensor information. In this manner, sensor information can be fed into platform 113 via the feature detector API in a logical form (e.g., to be added in the Boolean criteria equation or other logic).

The event platform 113 may include an event control module 203 with at least a calendar application (or other applications involving scheduling or tracking of events). The event control module 203 can determine what features are available to the system using feature detector APIs 209 and provide those features to an event organizer 211 via a user interface 207. In one embodiment, feature detector APIs 209 are a software and/or hardware implementation that can be specific to a sensor, which can measure a given feature—e.g., temperature, humidity, or any other sensor data. The APIs 209 enable interpretation of the sensor data—e.g., as provided by one of the services 109 or 111—so that the data can be understood and evaluated by the event control module 203.

Another aspect provides for the evaluation of the parameters according to the time and feature criteria provided by the event organizer 211. In a related embodiment, if the expression is satisfied, the event control module 203 requests final acceptance from the event organizer 205 and sends event calls to any potential participants. The event control module 203 can further collect replies and report on the status of the event. In another embodiment the event control module 203 triggers actions via the action APIs 209 such as launching a virtual meeting, sending a route plan to participants, etc.

In another embodiment, the event organizer 205 of event platform 113 receives information from the event control module 203 indicating the features available in system 100. The event organizer 205 can enter an expression (e.g., a Boolean or logical expression) in the user interface 207 that describes the criteria the features must fulfill to trigger event generation. Time-related criteria including the time at which the event control module 203 should evaluate the expression, the time at which an event call should occur, and a time by which potential participants must confirm, can also be entered by the event organizer 205. In other embodiments, the event organizer 205 specifies reply criteria and enables conditional participation. The event organizer 205 may additionally reply to requests for acceptance of an event call sent by the event control module 203.

A user interface 207 of the event platform 113 can include various methods of communication. For example, the user interface 207 can have outputs including a visual component (e.g., a screen), an audio component, a physical component (e.g., vibrations) and other methods of communication. User inputs can include a touch-screen interface, a scroll-and-click interface, a button interface, etc. Here, the user interface acts as a dedicated interface between the event organizer 205 and the event control module 203. In particular, the user interface 207 provides the available input parameters, as detected by the event control module 203, to the event organizer 205. Similarly, the user interface 207 provides the user profile information specifying criteria for the feature values, as entered by the event organizer 205, to the event control module 203.

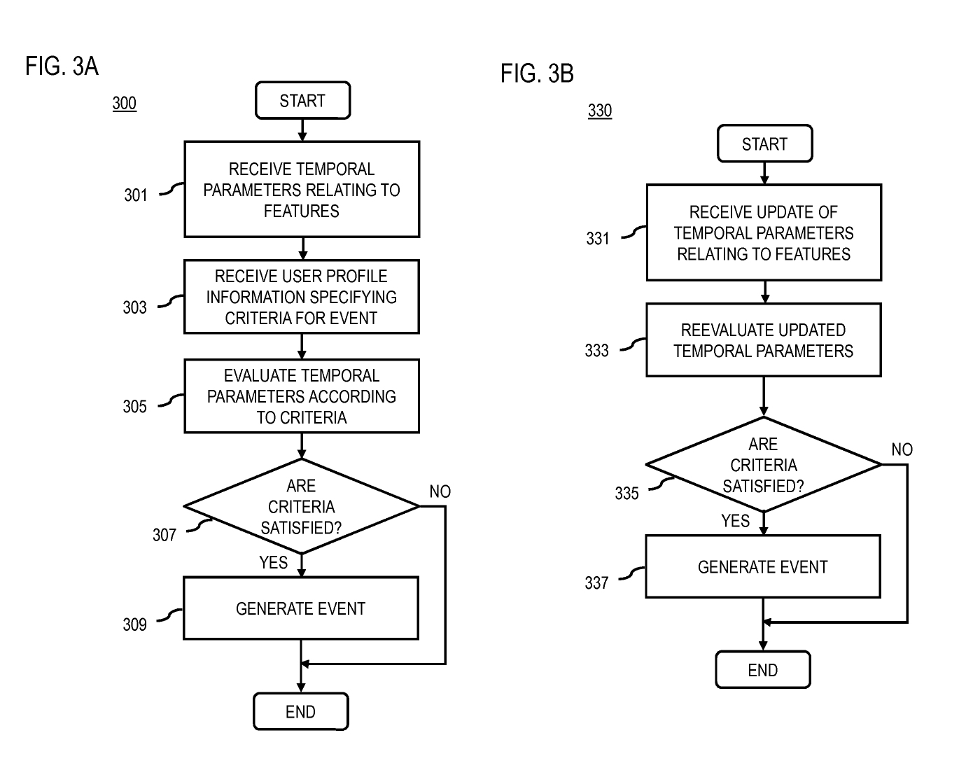

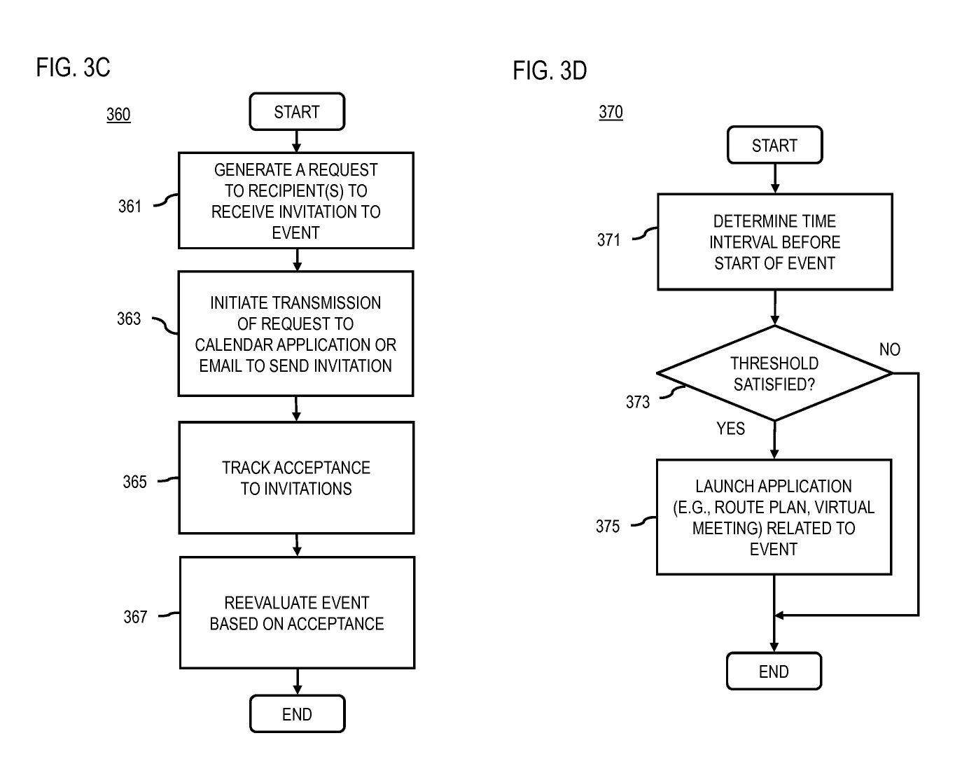

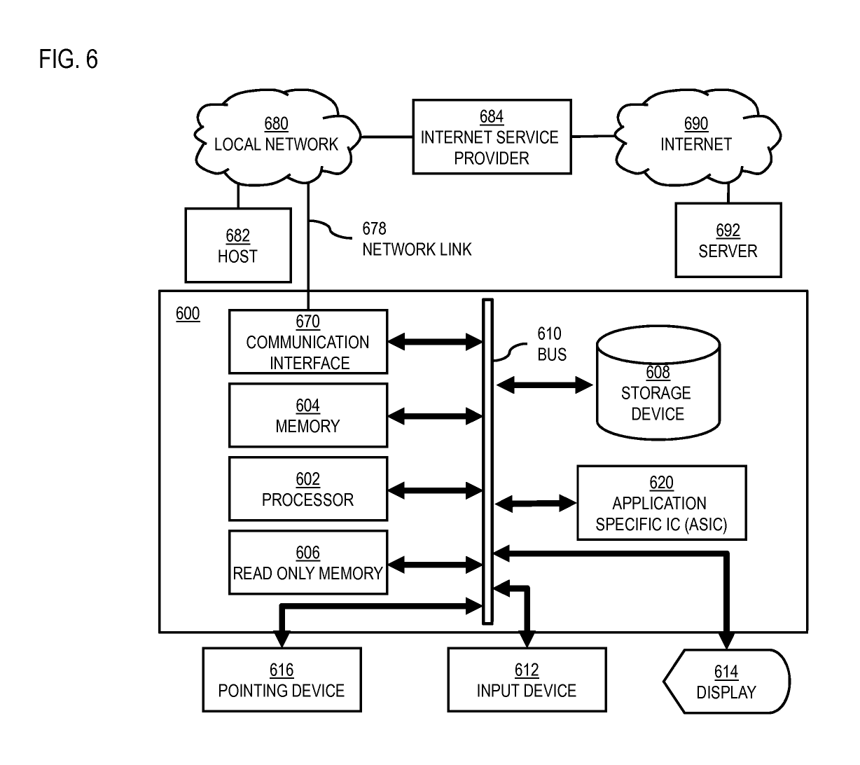

FIGS. 3A-3D are flowcharts of processes associated with generating and reevaluating events based on temporal parameters, according to various embodiments. Specifically, FIGS. 3A and 3B are flowcharts, respectively, of a process for generating an event based on temporal parameters, and a process for reevaluating temporal parameters to generate an event, according to various embodiments. As shown in FIG. 3A, in one embodiment, the event platform 113 performs the process 300 and is implemented in, for instance, a chip set including a processor and a memory as shown FIG. 6. It is noted that the steps of these processes may be performed in any suitable order, as well as combined or separated in any suitable manner. In step 301, event platform 113 receives temporal parameters relating to the available features of system 100 from, for example, services 109 and 111, via the communication network 105.

In step 303, the event platform 113 retrieves user profile information that specifies criteria associated with an electronic calendar event. For example, the event platform 113 can access features database 115 to retrieve a Boolean or other logical expression describing the conditions that must be met before a particular calendar event can be triggered. An expression for triggering an outdoor event might specify, for example, that the temperature be below 80 degrees and that humidity be less than 70 percent.

In step 305, the temporal parameters are evaluated according to the criteria retrieved in step 303. Using the example from that step, the temporal parameters for temperature and humidity would be evaluated at the time specified by the event organizer. If the criteria are satisfied, as in step 307, an event is generated (step 309). Conversely, if the criteria were not met, no event is generated.

Further, the above process can account for the updating of the temporal parameters (FIG. 3B). This process 330 involves receiving updates of the temporal parameters, as in step 331. Such update can be time-based; for example, within a predetermined time (e.g., 1 day) of the scheduled event, the temporal parameters are reassessed, as in step 333, to determine whether the event should be generated, or modified if previously generated. Upon satisfaction of the criteria, the event can be generated (steps 335 and 337).

According to one embodiment, a “refresh rate” can specify (e.g., by the user) the frequency of the update of the temporal parameters. Alternatively or additionally, an event trigger can be specified to modify or generate the conditional event; for instance, if the weather conditions deteriorate within a certain time period (e.g., 2 days) from the original scheduled date, the process can automatically update the temporal parameters for reevaluation. It is contemplated that if the event is modified in response to the updated parameters, the process can launch a notification to the participants to alert them of the change.

Turning now to FIG. 3C, this process 360 provides for disseminating electronic invitations to the scheduled event. In step 361, the process generates a request to have one or more recipients receive an invitation to participate in the event. The request is then transmitted, as in step 363, to an appropriate application, e.g., calendar application or email application, which distributes the electronic invitations. Alternatively, the process 360 can itself include generating the electronic invitations. Next, the process can track the acceptance (or positive acknowledgement, reply, or response) relating to planned attendance of the event, per step 365. In step 367, the process can reevaluate the event based on the projected or estimated number of attendees.

Furthermore, as seen in FIG. 3D, the conditional events mechanism provides great flexibility and convenience to the users. For instance, this process can integrate with other applications to gain more efficiencies among these applications. This advantageously can extend the battery life of the UE, in situation where the UE is a mobile phone, for example. As shown, in step 371, the process can determine a time interval (e.g., 1 hour, 30 minutes, 15 minutes, etc.) before start of the event. This time interval can be compared to a predetermined threshold (step 373), which in one embodiment, is configurable by the user. If the threshold is satisfied, the process can invoke an appropriate application to facilitate attendance and participation in the event, per step 375. According to one embodiment, the application can be a navigational (or mapping) application that can generate a route plan to the event. In this manner, the participants need not waste time and computer resources in determining their own route information. Moreover, this minimizes the chance for a user to produce an incorrect route, and thus, possibly missing the event. Furthermore, other applications can be launched. For example, a virtual meeting application can be automatically initiated to gather the participants.

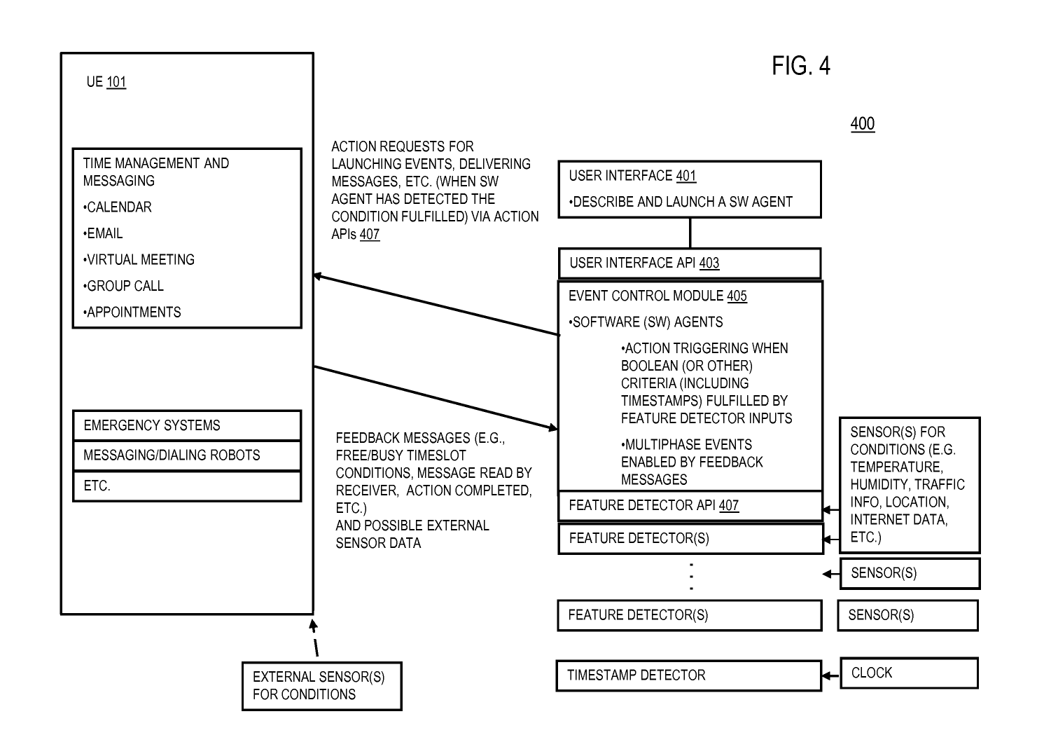

FIG. 4 is a diagram of a user device and associated user interfaces for generating conditional events based on the temporal values of features, according to one embodiment. System 400 is capable of generating conditional events based on the temporal values of features. In particular, FIG. 4 depicts various features of the event platform 113 described above with respect to FIG. 2, for example. Accordingly, system 400 includes a user interface 401 and user interface APIs 403. In one embodiment, an event control module 405 receives sensor data for various environmental, traffic and location conditions via feature detector APIs 407. In the system 400, event control module 405 evaluates criteria, including timestamps, upon whose fulfillment an action is triggered. Such actions can include a request to a phone robot to send an SMS message to a specific number, to turn an alarm system siren on, or to control an electric switch of some system.

In an example embodiment, the event control module 405 submits action requests via action APIs 407 to a UE 101. Actions, which are triggered upon fulfillment of the criteria, may include launching of events, delivery of messages, etc. The UE 101, upon which various time management and messaging applications reside, responds to the action requests from the event control module 403 by sending feedback messages indicating availability, reading of messages and completion of requested actions. The UE 101 may, in one embodiment, send data from an external sensor to the event control module 405. Also, as shown, one of the feature detectors involves a timestamp detector receiving timing information from a timing source, i.e., clock. Such information permits the user interface 401 to take appropriate actions with respect to criteria that are time-based (as earlier described). As seen, the UE 101 can also include applications/processes relating to emergency systems, messaging/dialing robots, etc. as well as relating to the dissemination of event information via the user interface 401.

In another embodiment, the UE 101 and event control module 405 of system 400 can be separate devices. A system of this configuration may further enable multiple UEs 101a-101n, where UEs 101a-101n can belong to different users.

The processes of FIGS. 3-4 may be executed using a variety of computing apparatuses and systems (or other means) to advantageously provide efficient use of networking and computing resources by eliminating unnecessary and/or redundant operations across multiple user systems.

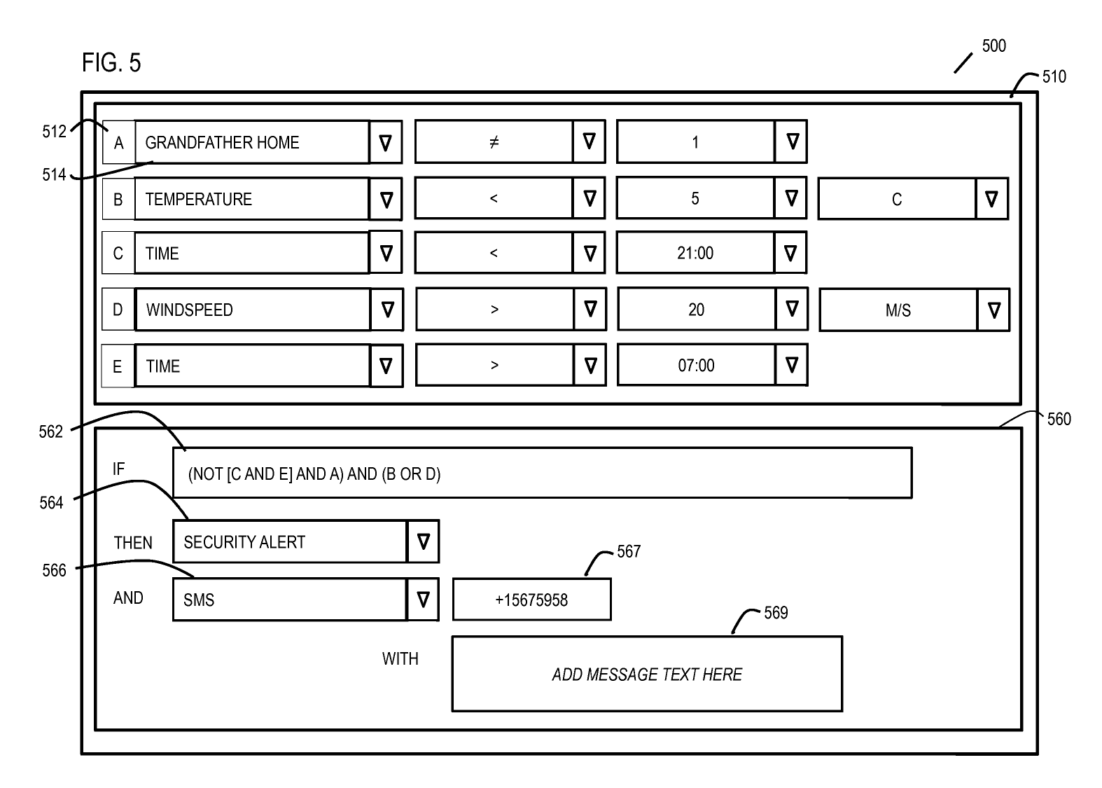

FIG. 5 is a diagram of an exemplary user interface 500, in one embodiment. Various user interfaces can be designed and linked to the system 400 via the user interface API (e.g., API 403 shown in FIG. 4.). The architecture of system 400 enables taking into account the target user group (children, teenagers, adults, senior citizen, handicapped persons, special interest/hobby groups, etc.) and associated level of complexity versus ease-of-use as well as design of the specific set of available feature detectors. In the embodiment of FIG. 5, the UI 500 comprises a first section 510 and a second section 560. The first section 510 enables the user to define criteria using the available parameters of the system 100, which can be selected via a drop-down list. Each line can represent a single condition, which is associated with an alphanumeric character. In the example UI 500, the condition defined in the first line is associated with “A”, the condition defined in the second line is associated with “B”, etc. In the first field of each line, the user can select a feature from among those available on the system 100, where the available features are determined using feature detector APIs 209, as described above with respect to FIGS. 2 and 4. The available features may include environmental conditions, time, user availability, etc. The remaining fields on each line enable the user to select the criteria to which the selected feature must adhere. For example, line 2 specifies that temperature must be less than 5 degrees Celsius. The first section 510 may further include an Add Criteria button which, when selected, triggers the appearance of an additional line for entry of an additional criteria.

In the second section 560 of the UI 500, the user can define a logical expression using one or more of the criteria set forth in the first section. The example depicted in the second section 560 of FIG. 5 uses an IF . . . THEN format that enables the user to enter a Boolean expression in an expression field 562 and one or more actions in action fields 564, 566, etc. Here, the user has specified the condition “NOT (C AND E)”, indicating that the user does not want the action(s) to occur between the hours of 7 am and 9 pm—i.e., the user wants the action(s) to occur at night. The user has additionally specified the condition “B OR D”, indicating the action(s) should occur when the temperature is less than 5 degrees Celsius or the wind speed is greater than 20 m/s (e.g., meter/sec). The action fields 564, 566, etc. enable the user to specify one or more action that will occur once the conditions of the Boolean expression are met. The user can select from among possible actions using a drop-down list of values and, depending on the action selected, additional fields can appear. In the example depicted, for example, selection of the action “SMS” triggers the appearance of a Phone Number field 567 and a Message field 569 wherein the user can enter a destination phone number and a textual message. The second section 560 may further include an Add Action button which, when selected, triggers the appearance of an additional action field.

The processes described herein for providing generation of conditional events based on the temporal values of user-defined features may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to generate conditional events based on the temporal values of user-defined features as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of the generation of conditional events based on the temporal values of user-defined features.

A bus 610 includes one or more parallel conductors of information so that information is transferred quickly among devices coupled to the bus 610. One or more processors 602 for processing information are coupled with the bus 610.

A processor 602 performs a set of operations on information as specified by computer program code related to generating conditional events based on the temporal values of features. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or other dynamic storage device, stores information including processor instructions for generating conditional events based on the temporal values of features. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for generating conditional events based on the temporal values of features, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT) or a liquid crystal display (LCD), or plasma screen or printer for presenting text or images, and a pointing device 616, such as a mouse or a trackball or cursor direction keys, or motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of application specific ICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for generating conditional events based on the temporal values of features to the UE 101.

The term “computer-readable medium” as used herein to refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

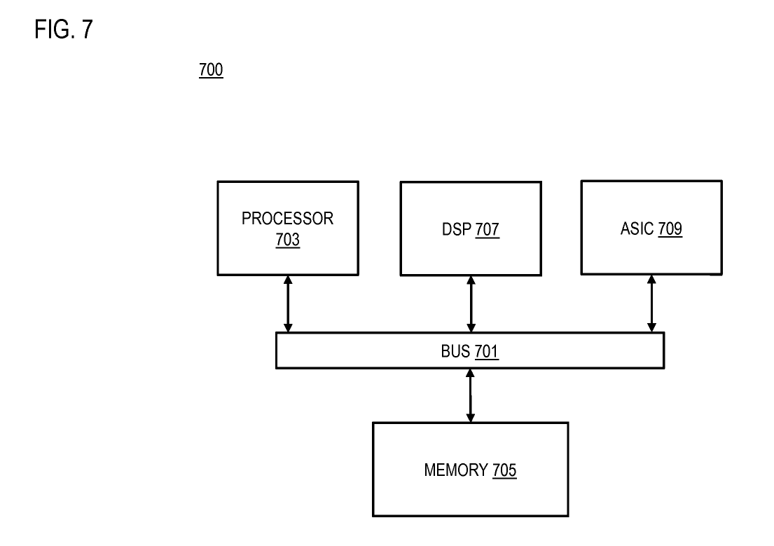

FIG. 7 illustrates a chip set 700 upon which an embodiment of the invention may be implemented. Chip set 700 is programmed to generate conditional events based on the temporal values of user-defined features as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 700, or a portion thereof, constitutes a means for performing one or more steps of the generation of conditional events based on the temporal values of user-defined features.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to generate conditional events based on the temporal values of user-defined features. The memory 705 also stores the data associated with or generated by the execution of the inventive steps.

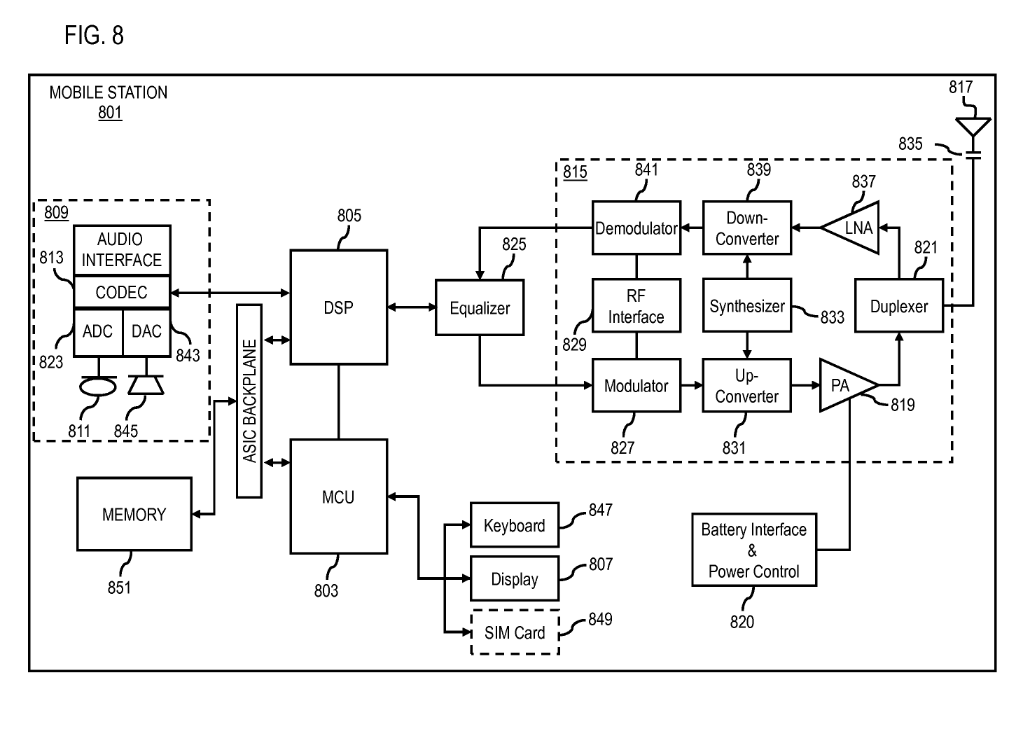

FIG. 8 is a diagram of exemplary components of a mobile terminal (e.g., handset) for communications, which is capable of operating in the system of FIG. 1, according to one embodiment. In some embodiments, mobile terminal 800, or a portion thereof, constitutes a means for performing one or more steps of the generation of conditional events based on the temporal values of user-defined features. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of the generation of conditional events based on the temporal values of user-defined features. The display 807 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs user interface software to facilitate user control of at least some functions of the mobile terminal 801 to generate conditional events based on the temporal values of user-defined features. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving one or more temporal parameters relating to a plurality of features;
retrieving user profile information specifying a predetermined criterion associated with an electronic calendar event;
evaluating the received temporal parameters according to the predetermined criterion; and
generating an event if the predetermined criteria are satisfied.

2. A method of claim 1, wherein the plurality of features are received from one or more systems configured to maintain values of the respective features, the features relating to either environmental condition, traffic condition, availability of users, or a combination thereof.

3. A method of claim 2, wherein the predetermined criterion specifies one or more threshold values for the respective features.

4. A method of claim 1, further comprising:
receiving an update of the temporal parameters; and
reevaluating the updated temporal parameters according to the predetermined criterion,
wherein the event is generated based on the reevaluation.

5. A method of claim 1, further comprising:
generating a request to have one or more recipients receive an invitation to participate in the event.

6. A method of claim 1, further comprising:
initiating invocation of an application relating to the generated event.

7. A method of claim 6, wherein the application provides either a virtual meeting for the generated event or a route to a location for the generated event.

8. An apparatus comprising:
at least one processor; and
at least one memory including computer program code,
the at least one memory and the computer program code configured to, with the at least one processor, cause the apparatus to perform at least the following,
receive one or more temporal parameters relating to a plurality of features;
retrieve user profile information specifying a predetermined criterion associated with an electronic calendar event;
evaluate the received temporal parameters according to the predetermined criterion; and
generate an event if the predetermined criteria are satisfied.

9. An apparatus of claim 8, wherein the plurality of features are received from one or more systems configured to maintain values of the respective features, the features relating to either environmental condition, traffic condition, availability of users, or a combination thereof.

10. An apparatus of claim 9, wherein the predetermined criterion specifies one or more threshold values for the respective features.

11. An apparatus of claim 8, wherein the apparatus is further caused, at least in part, to:
receive an update of the temporal parameters; and
reevaluate the updated temporal parameters according to the predetermined criterion,
wherein the event is generated based on the reevaluation.

12. An apparatus of claim 8, wherein the apparatus is further caused, at least in part, to:
generate a request to have one or more recipients receive an invitation to participate in the event.

13. An apparatus of claim 8, wherein the apparatus is further caused, at least in part, to:
initiate invocation of an application relating to the generated event.

14. An apparatus of claim 13, wherein the application provides either a virtual meeting for the generated event or a route to a location for the generated event.

15. A computer-readable storage medium carrying one or more sequences of one or more instructions which, when executed by one or more processors, cause an apparatus to at least perform the following steps:
receiving one or more temporal parameters relating to a plurality of features;
retrieving user profile information specifying a predetermined criterion associated with an electronic calendar event;
evaluating the received temporal parameters according to the predetermined criterion; and
generating an event if the predetermined criteria are satisfied.

16. A computer-readable storage medium of claim 15, wherein the plurality of features are received from one or more systems configured to maintain values of the respective features, the features relating to either environmental condition, traffic condition, availability of users, or a combination thereof.

17. A computer-readable storage medium of claim 16, wherein the predetermined criterion specifies one or more threshold values for the respective features.

18. A computer-readable storage medium of claim 15, wherein the apparatus is caused, at least in part, to further perform:
receiving an update of the temporal parameters; and
reevaluating the updated temporal parameters according to the predetermined criterion,
wherein the event is generated based on the reevaluation.

19. A computer-readable storage medium of claim 15, wherein the apparatus is caused, at least in part, to further perform:
generating a request to have one or more recipients receive an invitation to participate in the event.

20. A computer-readable storage medium of claim 15, wherein the apparatus is caused, at least in part, to further perform:
initiating invocation of an application relating to the generated event, the application providing either a virtual meeting for the generated event or a route to a location for the generated event.
